(19) United States
(12) Patent Application Publication
(10) Pub. No.: US 2009/0204279 A1
(43) Pub. Date: Aug. 13, 2009

(54) Torque minitoring for a hybrid drive

(76) Inventors: Gerit Von Schwertfuehrer, Bietigheim-Bissingen (DE); Volkmar Wuensch, Zwickau (DE); Holger Niemann, Ludwigsburg (DE); Per Hagman, Alingsas (SE)

Correspondence Address: KENYON & KENYON LLP, ONE BROADWAY, NEW YORK, NY, 10004, US

(21) Appl. No.: 11/991,436

(22) PCT Filed: Aug. 22, 2006
(86) PCT No.: PCT/EP2006/065534

§ 371 Date: Mar. 24, 2009

(30) Foreign Application Priority Data
Sep. 2, 2005 (DE) 102005041663.2

(51) Int. Cl. G06F 19/00

(52) U.S. Cl. 701/22; 180/65.265

(57) ABSTRACT

A method for monitoring torque in a hybrid drive made up of an internal combustion engine having an associated engine control unit and an intrinsically safe electric drive having an associated control unit, a protected communication taking place in which the engine control unit emits a setpoint torque to the control unit of the intrinsically safe electric drive and receives a status signal from it; and the engine control unit emitting an error signal in response to the exceeding of a permissible torque or in response to a negative status signal. If the intrinsic safety of the electric drive is used for the constant torque monitoring according to the specifications of the setpoint torque within the control unit, the data flow between the engine control unit of the internal combustion engine and the intrinsically safe electric drive may be reduced. As a result, the monitoring effort for the communication that is carried out in protected form between the engine control and the control unit is also reduced.

### FIELD OF THE INVENTION

The present invention relates to a method for monitoring torque in a hybrid drive made up of an internal combustion engine having an associated engine control unit and an intrinsically safe electric drive having an associated control unit, a protected communication taking place in which the engine control unit emits a setpoint torque to the control unit of the intrinsically safe electric drive and receives a status signal from it, and the engine control unit emitting an error signal in response to the exceeding of an permissible torque or in response to a negative status signal.

### BACKGROUND INFORMATION

Torque monitoring is used in order to establish a possible error function of a control unit for a vehicle drive or of the drive itself, for the protection of the vehicle's passengers as well as of the external traffic. For the torque monitoring, a permissible torque is ascertained constantly from the vehicle driver's command during operation, and is compared to an actual torque of the drive. In a hybrid drive made up of an internal combustion engine and an electric drive, the actual torque is ascertained from the sum of the actual torques of the internal combustion engine and the electric drive. For this purpose, data are exchanged between an engine control unit for the internal combustion engine and a controller of the electric drive.

### SUMMARY OF THE INVENTION

It is an object of the present invention to provide a method that makes possible the simplification of the communication between the controllers for the internal combustion engine and the electric drive.

The object is attained in that the intrinsic safety of the electric drive is used for the constant torque monitoring according to the specifications of the setpoint torque within the control unit. The communications effort (expenditure) may thereby be reduced. For reasons of safety, since the communication has to be executed as a protected communication, this also reduces the effort for monitoring of the communication between the engine control unit of the internal combustion engine, functioning in this case as powertrain coordinator and the control unit for the electric drive.

If only the setpoint torque of the intrinsically safe electric drive is passed on by the engine control unit to the control unit, the actual torque present in the control unit being used for the torque monitoring and only a status signal, that indicates a correct functioning of the communication and of the intrinsically safe electric drive, is passed on to the engine control unit, and if an error signal is emitted in response to the exceeding of a permissible torque or in response to a negative status signal, it may be achieved that the torque monitoring is safe, although the actual torque of the electric drive is not reported to the powertrain coordinator. The reduced communications effort simplifies the overall system.

In one preferred specific embodiment of the method, the permissible torque of the drive is compared to the sum of an actual torque of the internal combustion engine and the setpoint torque of the intrinsically safe electric drive, and an error signal is emitted if the sum, thus formed, exceeds the permissible torque. It may thereby be achieved that a reliable torque monitoring is able to take place, although the actual torque of the electric drive is not reported to the powertrain coordinator.

In one refinement of the method, the engine control unit sends a setpoint torque, internally checked for plausibility, to the intrinsically safe electric drive, and the control unit emits a positive status signal if the actual torque reaches the setpoint torque, and emits a negative status signal if the actual torque does not reach the setpoint torque. In this embodiment, as compared to an intrinsically safe design of the electric drive, no additional signals have to be generated or derived, and the system may advantageously be developed as simply as possible, the required safety being able to be achieved in spite of this.

### BRIEF DESCRIPTION OF THE DRAWINGS

FIG. 1 shows, schematically, a continuous torque monitoring for an internal combustion engine according to the related art.

FIG. 2 shows the signal flow between the engine control unit and the control unit of the electric motor in an embodiment according to the present invention.

### DETAILED DESCRIPTION

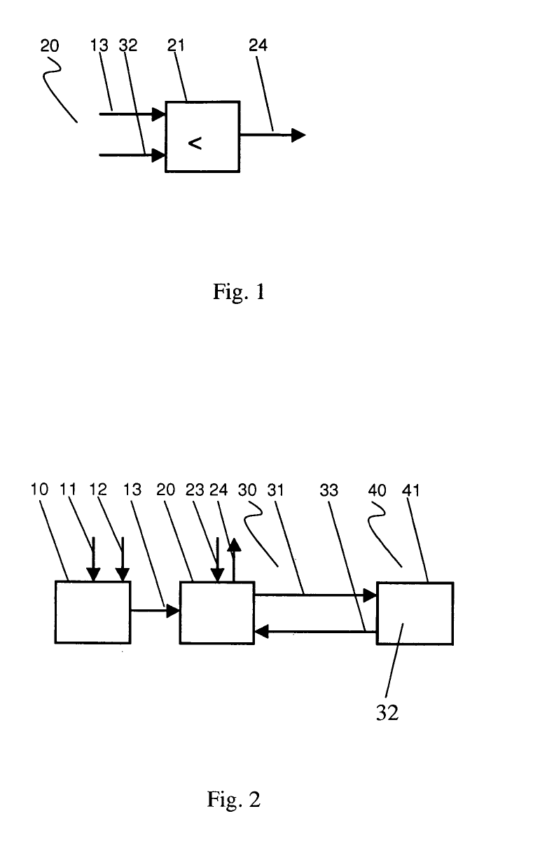

FIG. 1 shows a torque monitoring for an internal combustion engine having an associated engine control unit 20. For the purpose of revealing faulty functioning of the control, the ascertainment of a permissible torque 13 is provided which is compared to an actual torque 32 in a comparison stage 21. If it is established that actual torque 32 is greater than permissible torque 13, it is concluded that there is faulty functioning, and an error signal 24 is emitted.

FIG. 2 shows a torque monitoring having simplified communication 30, according to the present invention, between engine control unit 20 of the internal combustion engine and control unit 41 of intrinsically safe electric drive 40. Permissible torque 13 is determined as in the related art. A setpoint torque 31 for electric drive 40 is also derived from the driver's command. Since this electric drive 40 is designed to be intrinsically safe, it may be reported to engine control unit 20, via status signal 33, whether the requested setpoint torque 31 is able to be set. To achieve the intrinsic safety of electric drive 40, actual torque 32 has to be present in control unit 41. Therefore, setpoint torque 31 within control unit 41 is able to be compared to actual torque 32 ascertained there. If setpoint torque 31 cannot be set, a corresponding status message is able to be transmitted via status signal 33. In engine control unit 20, permissible torque 13 may be compared to the sum of the actual torque of the internal combustion engine and setpoint torque 31 of electric drive 40, and if it exceeds it, an error signal 24 is emitted. The actual torque of the internal combustion engine, in this context, may be derived from measured values 23, in the case of an Otto engine, for instance, the air quantity, the ignition angle and/or the output signal of the lambda probe may be used, or signals derived from these. In the case of a Diesel engine, injection parameters, such as fuel pressure, valve opening and closing times or values derived therefrom may be used as measured values 23.

The transmission of actual torque 32 of electric drive 40, as well as its processing in engine control unit 20 may be omitted. Because of this, the requirement for communication between engine control unit 20 and control unit 40 may be reduced.

1-4. (canceled)

5. A method for monitoring torque in a hybrid drive made up of an internal combustion engine having an associated engine control unit and an intrinsically safe electric drive having an associated control unit, the method comprising:
providing a protected communication in which the engine control unit emits a setpoint torque to the control unit of the electric drive and receives a status signal from the control unit of the electric drive, and the engine control unit emits an error signal in response to an exceeding of a permissible torque or in response to a negative status signal; and
using an intrinsic safety of the electric drive for a constant torque monitoring according to specifications of the setpoint torque within the control unit of the electric drive.

6. The method according to claim 5, wherein only the setpoint torque of the electric drive is passed on by the engine control unit to the control unit of the electric drive, an actual torque present in the control unit of the electric drive being used for the torque monitoring, and only a status signal, that indicates a correct functioning of the communication and of the electric drive, being passed on to the engine control unit, and the error signal being emitted in response to the exceeding of a permissible torque or in response to a negative status signal.

7. The method according to claim 5, further comprising:
comparing the permissible torque of the drive to a sum of an actual torque of the internal combustion engine and a setpoint torque of the electric drive; and
emitting an error signal if the sum exceeds the permissible torque.

8. The method according to claim 5, wherein the engine control unit sends a setpoint torque, that was internally checked for plausibility, to the electric drive, and the control unit of the electric drive emits a positive status signal if an actual torque reaches the setpoint torque, and emits a negative status signal if the actual torque does not reach the setpoint torque.
